(19) United States
(12) Patent Application Publication
(10) Pub. No.: US 2015/0160075 A1
(43) Pub. Date: Jun. 11, 2015

(54) CANE-BASED U-BEND

(71) Applicant: Weatherford/Lamb, Inc., Houston, TX (US)

(72) Inventors: Domino TAVERNER, Delray Beach, FL (US); Edward M. DOWD, Madison, CT (US); David LABELLA, Higganum, CT (US)

(21) Appl. No.: 14/517,498

(22) Filed: Oct. 17, 2014

Related U.S. Application Data
(60) Provisional application No. 61/892,832, filed on Oct. 18, 2013.

(51) Int. Cl. G01K 11/32; G02B 6/125

(52) U.S. Cl. CPC G01K 11/32; G02B 6/125; G01K 2011/324

(57) ABSTRACT

Large diameter optical waveguides (cane) may stiffen as diameter increases. The minimum bend radius may become larger than is practical for many applications. Standard-sized optical fibers may be fusion spliced to the ends of a cane segment where the fusion splice area is protected with a high temperature coating such as polyimide. The cane segment is then heated (e.g., using a hot flame torch or arc) and bent to form a U-bend, or other angle, that is free of bending stress. The heated glass may be shaped, while maintaining the waveguide properties of the cane. Once cooled, the cane maintains the new shape. Therefore, light may be propagated around the bend or angle. Thus, many configurations of cane devices may be fabricated. Some examples of cane configurations include coils, U-turns (U-bends), angled inputs/outputs, etc. Bent cane may be useful for loop-back operations, such as double-ended Raman distributed temperate sensing (DTS).

### CLAIM OF PRIORITY UNDER 35 U.S.C. §119

This application claims benefit of U.S. Provisional Patent Application Ser. No. 61/892,832, filed Oct. 18, 2013 and entitled “CANE-BASED U-BEND,” which is herein incorporated by reference in its entirety.

### BACKGROUND

1. Field of the Disclosure

Aspects of the disclosure generally relate to large diameter optical waveguides (cane) and, more particularly, to techniques for bending cane, a cane-based U-bend, and applications thereof.

2. Description of Related Art

Large diameter optical waveguides (also known as cane waveguides), such as described in U.S. Pat. No. 6,982,996 to Putnam et al., filed Dec. 6, 1999, entitled “Large Diameter Optical Waveguide, Grating, and Laser,” and hereby incorporated by reference, are rigid structures unlike optical fibers and have a core similar in size to that of a conventional optical fiber. However, cane waveguides have a much larger cladding than optical fibers. The core in a cane waveguide for a single mode of transmission is approximately 4 to 9 microns in diameter, while the core in a cane waveguide for multi-mode transmission is approximately 50 to 60 microns in diameter. Unlike the 125 μm outer diameter of the optical fiber, the outer diameter of the cladding of a cane waveguide is approximately 1 to 10 mm for either single mode or multi-mode transmission.

Some optical sensing applications, such as Raman double-ended distributed temperature sensing (DTS) measurements, may use a fiber loop for interrogating a fiber length from both fiber ends. In many instances, the fiber loop is completed by joining the ends of two fibers within a cable at one end of the cable to form a “turnaround.” In downhole oil and gas well sensing systems, it is often desirable to provide a small profile at the turnaround end of the cable. In many cases, it is also desirable that the turnaround be able to operate for the lifetime of the well at pressures up to 25000 psi and temperatures up to and above 300° C. The turnaround unit may also be packaged for protection from these extremes.

AFL Telecommunications LLC has developed a product named Minibend™. This product is manufactured by heating, stretching, and bending a bare segment of optical fiber to form a U-shaped fiber turnaround. The bent segment is under little or no stress from bending due to the heat-while-bending process. The small U-bend section is then mounted to a glass plate within a small glass tube, using silicone or other adhesive. The profile of the Minibend™ assembly is approximately 2 mm in diameter. This design works well, but is limited to operating temperatures below 200° C.

Schlumberger Ltd. has developed a method of creating and inserting a looped optical fiber into a small diameter tube. The ends of the looped fiber are then spliced to the fibers at the cable end. To aid with reliable long-term operation, the fiber segment used for the loop is first tensile-proof tested at a high load to ensure there are no defects in the fiber that would break while under the deployed bending stress. The proof test level is determined from a calculation for statistically determining lifetime reliability of the bending stress load. The difficulty with this is that lifetime reliability models of stressed fibers are based on stress corrosion parameters of glass that are highly dependent on the surrounding environment and temperature. It seems that in order to provide a glass fiber with reasonable bend reliability at elevated temperature and possible chemical environments, the fiber proof test levels may most likely approach the theoretical strength limits of glass.

Qorex LLC has developed a method to provide an optical fiber-based U-bend. In this method, an optical fiber is bent to a small diameter U-bend and is subsequently heated to reduce or eliminate the bend stresses. The heating process likely burns off traditional fiber coatings (even polyimide) and may most likely involve protecting the annealed bare fiber bend or providing a metallic coated fiber segment for bending and heating. Similar to AFL's design, the bent section entails protection of some sort.

The optical fiber-based U-bend solutions above may not meet the high pressures and temperatures for some downhole operations. Therefore, there exists a need for more robust U-bend waveguides able to withstand pressures and temperatures of a downhole environment, for use in certain applications such as Raman DTS.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include cane-based U-bend.

Aspects of the disclosure generally relate to methods and apparatus for bending (e.g., turnaround) a large diameter optical waveguide, such as a cane waveguide. As used herein, a large diameter optical waveguide (also known as a cane waveguide or simply “cane”) generally refers to an optical waveguide having a core and a cladding, wherein an outer diameter of the cladding is at least 1 mm.

Certain aspects of the present disclosure provide a method for forming a large diameter optical waveguide having a bend. The method generally includes mounting an end of the large diameter optical waveguide to a fixture such that the large diameter optical waveguide is horizontal, heating a first segment of the large diameter optical waveguide, and bending the heated first segment of the large diameter optical waveguide.

Certain aspects of the present disclosure provide a method for determining temperatures associated with a conduit. The method generally includes performing Raman DTS at a first end of a large diameter optical waveguide comprising a U-bend, the first end, and a second end to obtain a first set of backscattered signals from a plurality of locations, wherein the U-bend is disposed within a first portion of the conduit, and wherein the first end and the second end of the large diameter optical waveguide are disposed within a second portion of the conduit separated from the first portion by a length of the conduit; performing Raman DTS at the second end of the large diameter optical waveguide to obtain a second set of backscattered signals from the plurality of discrete locations; and performing double-ended DTS calculations using the first set of backscattered signals and the second set of backscattered signals to obtain a temperature profile of the optical waveguide.

Certain aspects of the present disclosure provide a system for determining temperatures associated with a conduit. The system generally includes a large diameter optical waveguide disposed in the conduit, the waveguide comprising a first end, a second end, and a U-bend; an optical source for introducing pulses of light into the first end and the second end of the large diameter optical waveguide; and at least one processor configured to perform Raman DTS using the first end of the large diameter optical waveguide to obtain a first set of backscattered signals, perform Raman DTS using the second end of the large diameter optical waveguide to obtain a second set of backscattered signals, and perform double-ended DTS calculations using the first set of backscattered signals and the second set of backscattered signals to obtain a temperature profile of the optical waveguide.

Certain aspects of the present disclosure provide a bent large diameter optical waveguide for downhole sensing. The bent large diameter optical waveguide generally includes a core, a cladding disposed around the core, wherein the core and the cladding are bent, and a sleeve disposed around the cladding.

Certain aspects of the present disclosure provide a method for determining temperatures and strains associated with a conduit. The method generally includes introducing a first signal at a first end of an optical waveguide comprising a large diameter portion having a U-bend, the first end, and a second end, wherein the U-bend is disposed within a first portion of the conduit and wherein the first end and the second end of the optical waveguide are disposed within a second portion of the conduit separated from the first portion by a length of the conduit, introducing a second signal at the second end of the optical waveguide to stimulate a set of backscattered signals from the first signal, and performing distributed temperature and strain sensing (DTSS) calculations using the set of backscattered signals to obtain a temperature profile and a strain profile of the optical waveguide.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this disclosure and are therefore not to be considered limiting of its scope, for the disclosure may admit to other equally effective aspects.

FIG. 1 illustrates various operations in fabricating an example bent cane preform assembly, in accordance with certain aspects of the present disclosure.

FIG. 2 illustrates an example process to form a cane U-bend from the preform assembly of FIG. 1, in accordance with certain aspects of the present disclosure.

FIG. 3 illustrates an example cane U-bend assembly for attachment to a downhole cable, in accordance with certain aspect of the present disclosure.

FIG. 4 illustrates an example downhole cable assembly, in accordance with certain aspects of the present disclosure.

FIG. 5 illustrates an example process to attach the cane U-bend assembly of FIG. 3 to the downhole cable assembly of FIG. 4, in accordance with certain aspects of the present disclosure.

FIG. 6 illustrates an example prior art Raman distributed temperature sensing (DTS) system for measuring temperature.

FIG. 7 is a graph of intensity versus frequency where the waveform illustrates various types of light scattering, in accordance with certain aspects of the present disclosure.

FIG. 8 illustrates an example Raman double-ended DTS system having a cane U-bend, in accordance with certain aspects of the present disclosure.

FIG. 9 illustrates a zoomed-in view of an example bent large diameter optical waveguide with a U-bend, in accordance with certain aspects of the present disclosure.

FIG. 10 illustrates an example bent large diameter optical waveguide formed into a coil, in accordance with certain aspects of the present disclosure.

FIG. 11 illustrates an example bent large diameter optical waveguide with a surface to be polished, in accordance with certain aspects of the present disclosure.

FIG. 12 illustrates an example first polished bent large diameter optical waveguide fused with a second polished bent large diameter optical waveguide, in accordance with certain aspects of the present disclosure.

FIG. 13 is a flow diagram illustrating example operations for forming a large diameter optical waveguide having a bend, in accordance with certain aspects of the present disclosure.

FIG. 14 is a flow diagram illustrating example operations for determining temperatures associated with a conduit, in accordance with certain aspects of the present disclosure.

FIG. 15 is a flow diagram illustrating example operations for determining temperatures and strains associated with a conduit, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Large diameter optical waveguides (e.g., cane) may stiffen as the diameter of the waveguide increases. At high enough diameter, the minimum bend radius may become larger than is practical for many applications. In addition, when bent, the waveguide is under stress and may be fixed in place in order to remain bent, since the relaxed state is a straight cane. For many applications, bending may not be practical.

For certain applications, processing steps may be more difficult due to the limitation of a straight cane. For example, side polishing a cane to produce a “D”-shaped waveguide for evanescent field sensors may be complicated by the fact that the end portions of the cane may not be machined to allow use of standard techniques for coupling in and out of the sensor portion, which may prevent use of standard polishing techniques.

In some approaches, long straight devices have been produced, possibly limiting the length below the optimum for the device. Another approach is to restrict the diameter of the cane, possibly below the optimum for the device. In yet another approach, techniques for processing a straight cane have been developed which may be complex and expensive.

The above-described approaches involve designing a system within the limitations and constraints of the cane stiffness. Therefore, certain aspects of the present disclosure provide techniques for bending a cane, for example, to form a small form factor turnaround (e.g., U-bend), which may have a bend radius, may have angled input and output connections, and may be bent with less stress.

### Example Cane-Based U-Bend

Aspects of the disclosure generally relate to methods and apparatus for bending (e.g., turnaround) a large diameter optical waveguide, such as a cane waveguide. For certain aspects, a cane waveguide is used for the turnaround. The cane waveguide has cladding that is larger in overall diameter and more rugged than an optical fiber, but has the same (or substantially similar) optical core characteristics. Standard-sized optical fibers may be fusion spliced to the ends of a cane segment where the fusion splice area is protected with a high-temperature coating such as polyimide. The cane segment is then heated and bent to form a U-bend turnaround that is free of bending stress. To provide protection from the downhole environment, the U-bend may be packaged in a metal housing, which is then welded to the cable end for a permanent leak-free seal from downhole fluids.

The bent cane may have applications including angling input/output connections on a cane sensor to allow side-polishing using conventional techniques; compact packaging of large diameter amplifier waveguides for high-power and high-energy laser systems; compact, monolithic U-turns; and monolithic couplings for harsh environments. The bent cane configurations described herein may also allow a unique approach for performing loop-back measurements, such as Raman distributed temperature sensing (DTS).

Cane is larger in overall diameter and more rugged than an optical fiber but has the same optical core characteristics. Standard-sized optical fibers may be fusion spliced to the ends of a cane segment, where the fusion splice area may be protected with a high temperature coating, such as polyimide. The cane segment may then be heated and bent to form a U-bend turnaround that is free of bending stress. To provide protection from the downhole environment, the U-bend may be packaged in a metal housing (e.g., nickel alloy), which is then welded to the cable end for a permanent leak-free seal from downhole fluids. The cane segment may be rigid enough to not have a protective coating for reliability and may be held in place using a mechanical mount or high temperature adhesive or solder.

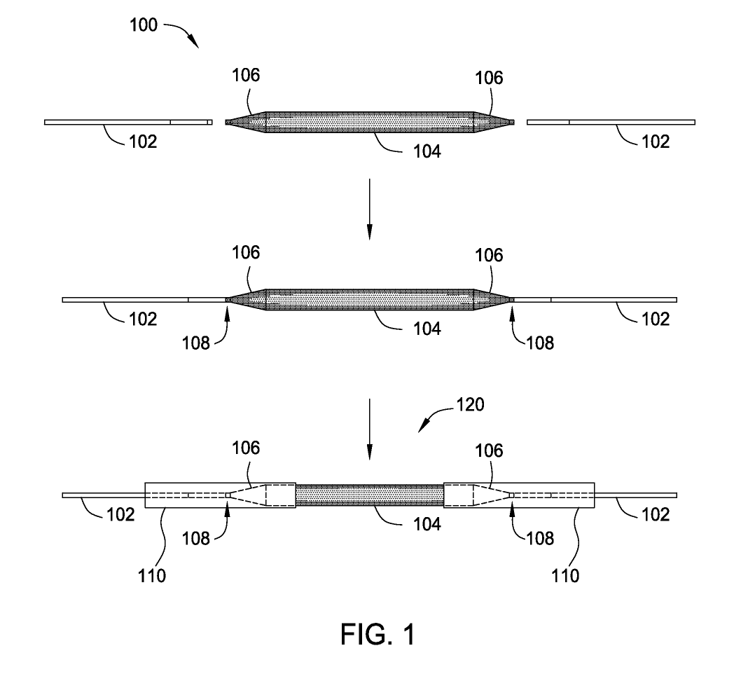

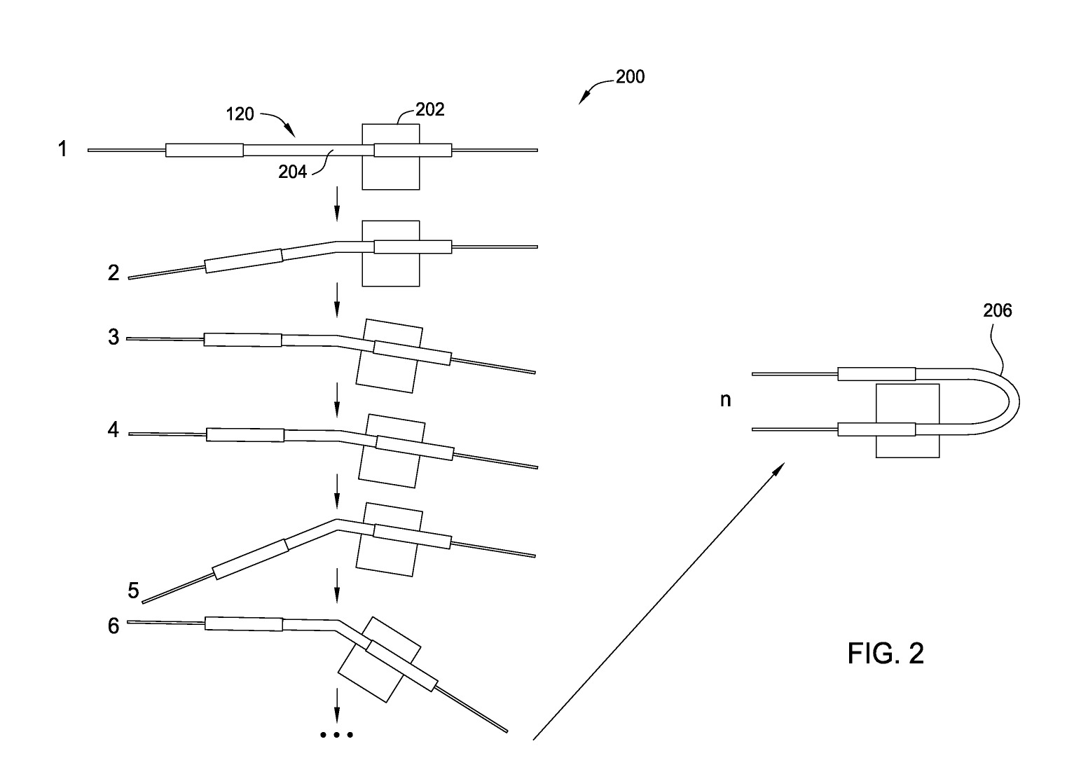

FIG. 1 illustrates various operations 100 in producing an example bent cane preform assembly 120, in accordance with certain aspects of the present disclosure. According to certain aspects, the assembly may be fabricated by attaching optical fibers 102 (e.g., fiber pigtails) to each end of a cane segment 104. The cane segment 104 may be heated to form an angle (e.g., 180° or greater) as discussed in more detail below with respect to FIG. 2. According to certain aspects, to attach the optical fibers 102, the cane segment 104 may be prepared by cutting a cane to length and then machining the ends 106 of the cane to form two frustoconical sections where the diameters of the sections' tapered ends approximately equal the diameter of the optical fibers 102 to be attached. The cane ends 106 may be fusion spliced at areas 108 to the fiber pigtails (e.g., using commercially available fusion splice machines). According to certain aspects, use of certain fusion splice machines may allow for fusion of the cane ends 106 to the fiber pigtails without performing the cane machining step. According to certain aspects, the fusion-spliced areas 108 may then be recoated with any suitable coating (e.g., polyimide). At each end, a strain-relief tube 110 (comprising polyimide, for example) may be slid over the spliced area 108 onto the tapered cane end 106 to form the preform assembly 120. The strain-relief tubes 110 may prevent the spliced areas 108 from excessive bending which may break the fusion splices.

According to certain aspects, the preform assembly (e.g., the perform assembly 120 shown in FIG. 1) may be bent to form a U-shape, generally referred to herein as a “U-bend.” FIG. 2 illustrates an example process 200 to form a cane U-bend, in accordance with certain aspects of the present disclosure. As shown in FIG. 2, one end (e.g., cane end 106) may be held in fixture 202 such that the cane lies horizontally. Formation of a bend may be started by heating a narrow (e.g., 1 mm wide) section 204 of the cane (e.g., cane segment 104) to melt. According to certain aspects, a hot flame torch (or any other suitable method) may be used to soften a glass cane (e.g., the bent cane preform assembly 120). According to certain aspects, an arc splicer may be used for heating and softening the cane. The arc splicer may be a large diameter arc splicer using a three-electrode arc, for example. According to certain aspects, the heat source may also be an electric element or laser.

According to certain aspects, after heating to melt, the cane may be shaped through angles and bends, while maintaining the waveguide properties of the cane. According to certain aspects, the bend may be forced by fixtures or by gravity. To bend the cane using gravity, after heating the cane to soften it, the cane's own weight under gravity may be used to bend the cane, for example, by fixing one end of the cane preform assembly 120 and turning or rotating the assembly to achieve a desired bend or shape. The turning or rotating may be performed in multiple steps as shown in FIG. 2.

In one example implementation illustrated in FIG. 2, a slight (e.g., 10-15°) bend to the free (unfixed) cane end may be made (step 2). The fixture 202 is then rotated until the free end is horizontal again (step 3). The heat source may then be moved to target a location adjacent to the first bend, and the bend process may be repeated until the cane is bent (e.g., to at least 180°) forming a U-shape (steps 4-n), which is referred to as a U-bend 206. According to certain aspects, the cane preform assembly 120 may be bent into one or more coils.

According to certain aspects, maintaining a smooth radius of curvature—without kinks in the waveguide—may be desired in order to preserve the optical characteristics of the cane.

Once cooled, the cane maintains the new shape. Therefore, light may be propagated around the bend or angle. Thus, many new configurations of cane devices may be fabricated. Some examples of cane configurations include coils, U-turns (U-bends), angled inputs/outputs, etc.

The upper temperature limit of the U-bend system may be limited only by the fiber coatings and the U-bend cane mounting mechanism. Being made from a glass of larger diameter than fiber and free from bending stresses, the cane-based U-bend is more reliable than fiber U-bends.

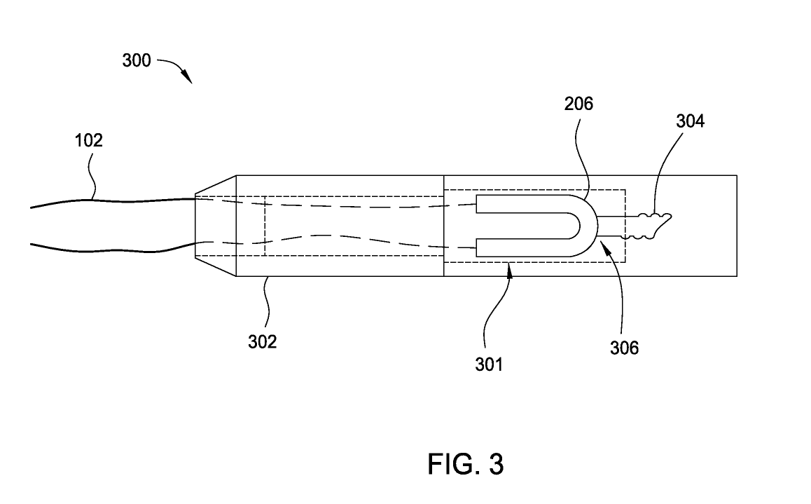

FIG. 3 illustrates an example cane U-bend assembly 300 for attachment to a downhole cable, in accordance with certain aspect of the present disclosure. According to certain aspects, the fabricated cane segment 301 with U-bend 206 may be mounted inside a protective metal housing 302, which may be assembled to the end of a downhole cable as shown in FIG. 3. According to certain aspects, after attachment of the optical fibers 102 and bending (e.g., as shown in FIG. 2), the fabricated cane segment 301 with U-bend 206 may be fastened to the inside of the metal housing 302. To avoid direct contact of the cane to the metal housing 302, a tube 304 (e.g., made of cured polyimide) may be attached to the cane's U-bend 206 using adhesive 306 (e.g., polyimide adhesive). The opposite end of the tube 304 may then be attached to the metal housing 302 with the adhesive 306. The tube 304 may provide for isolation of the glass cane from the metal housing 302 and may offer the cane U-bend some resiliency to vibration and shock.

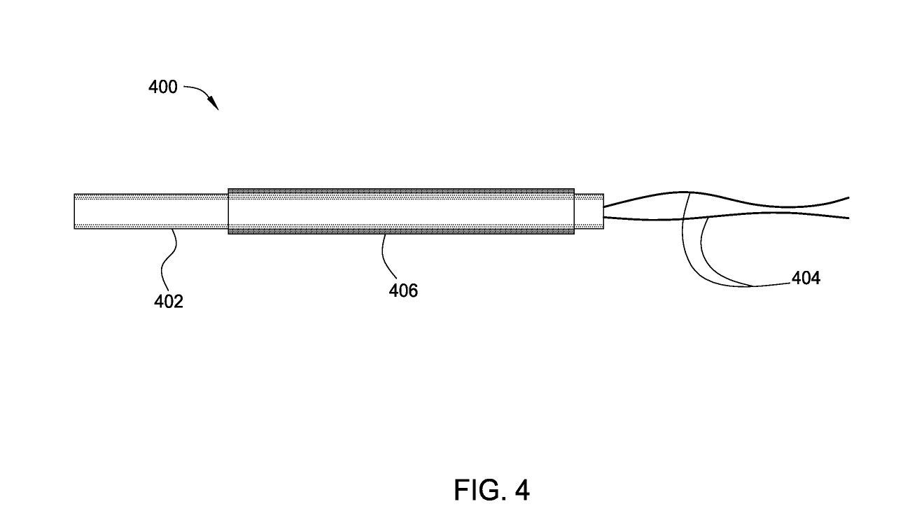

FIG. 4 illustrates an example downhole cable assembly 400. As shown in FIG. 4, for attachment of the cane U-bend assembly 300 to the end of the metal-jacketed downhole cable assembly 400, the cable 402 may be terminated to provide lengths of optical fibers 404 for splicing to the mounted U-bend fibers 102. At some point, (e.g., prior to terminating the cable 402), a metal splice tube 406 may be slid over the cable end.

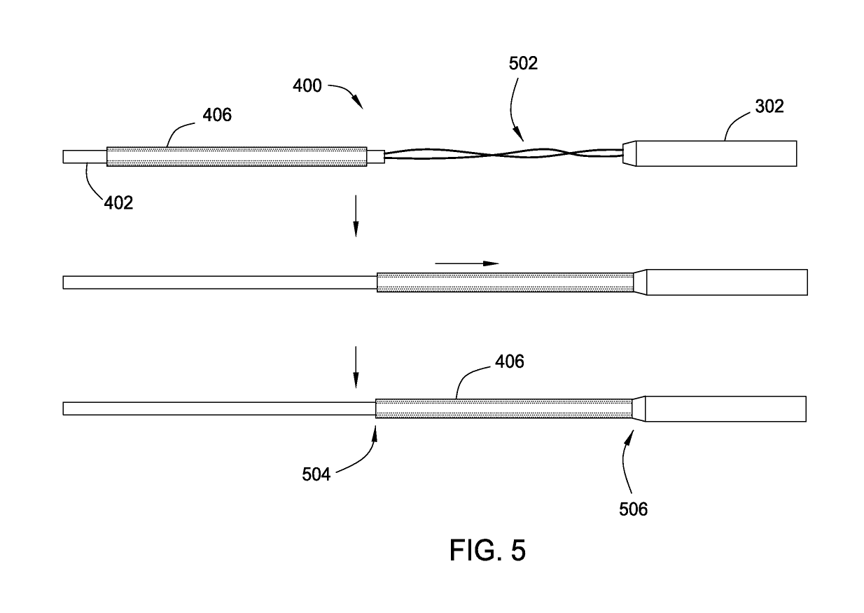

FIG. 5 illustrates example attachment of the cane U-bend assembly 300 to the downhole cable assembly 400, in accordance with certain aspects of the present disclosure. As illustrated in FIG. 5, the optical fibers 404 may be fusion spliced to the optical fibers 102, and the spliced areas 502 of the optical fibers may be recoated using any of various suitable coatings, such as a polyimide adhesive. According to certain aspects, the splice tube 406 may then be slid from the cable 402 over the spliced fibers 404, 102 to the cane U-bend metal housing 302. The ends of the splice tube 406 may then be welded at weld locations 504, 506 (e.g., using an orbital Tungsten inert gas (TIG) welder). For example, one end of the splice tube 406 may be welded at location 504 to the metal jacket of the downhole cable 402, and the other end may be welded at location 506 to the cane U-bend metal housing 302. The downhole cable assembly produced in FIG. 5 may provide for a fully welded, fluid-tight seal to protect the cane U-bend assembly 300 from the downhole environment.

The bent-cane configurations described herein may have several applications including angling input/output connections on a cane sensor to allow side-polishing using conventional techniques (e.g., circular polishing pads); compact packaging of large-diameter amplifier waveguides for high-power and high-energy laser systems; compact, monolithic U-turns; and monolithic couplings for harsh environments. These bent-cane configurations may also provide a unique approach to performing loop-back measurements, such as Raman distributed temperature sensing (DTS). Other loop-back methods may also be enabled. Looping back at ultra high temperatures (e.g., above 300° C.) in a relatively small form factor may also be enabled.

### Example Applications for Bent Cane

Bent cane as described above may be suitable for use in numerous applications. Some of these are described below.

### Raman Distributed Temperature Sensing (DTS)

According to certain aspects, a large diameter optical waveguide with a U-bend may be useful for certain applications, such as DTS. DTS is a technique for monitoring temperature along the length of a wellbore utilizing an optical waveguide, such as an optical fiber or a cane, as a temperature sensor. DTS employs an optical waveguide as both the communication line and the temperature sensor.

In a typical DTS system, a laser or other light source at the surface of the well transmits a pulse of light into an optical waveguide (e.g., a fiber optic cable) installed along a length of a well. Due to interactions with molecular vibrations within the glass of the waveguide, a portion of the light is scattered back towards the surface (this phenomenon is referred to as Raman scattering).

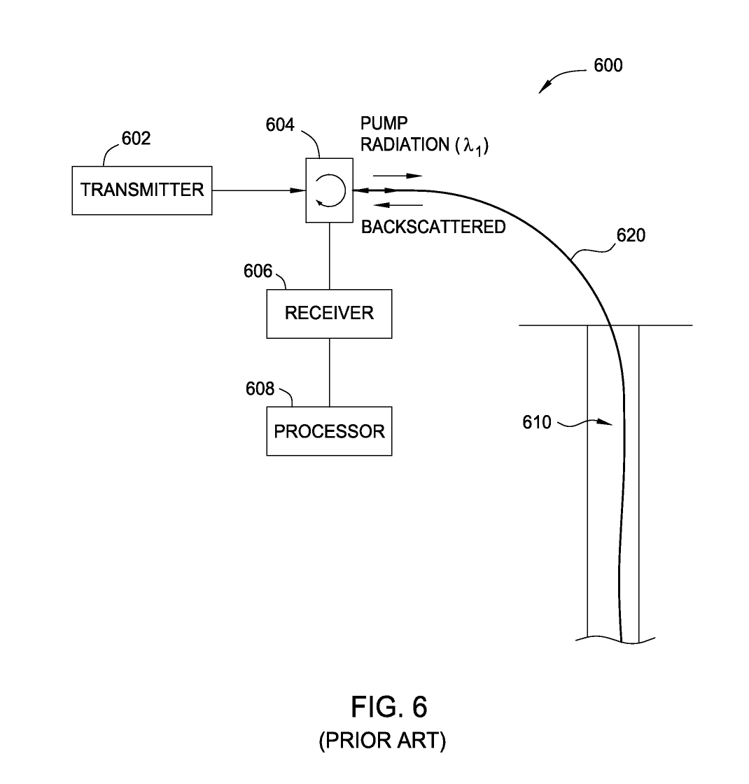

FIG. 6 illustrates an example DTS system 600 for measuring the temperature, in a wellbore 610, for example. A transmitter 602 irradiates a waveguide 620 with light signals (e.g., pump radiation) capable of causing Raman scattering. For example, the transmitter 602 may comprise a laser or other light source, which may be located at the surface of the well and may transmit a pulse of light into the waveguide 620. According to certain aspects, the waveguide 620 may comprise a fiber optical cable (e.g., similar to fiber optical cable 402). The light pulse excites atoms as it propagates through the waveguide 620, causing the stimulated atoms to, among other activities, reflect detectable light back towards the surface for detection. The frequency of the reflections relative to the pulsed light are shifted in accordance with the temperature of the atoms along the waveguide 620. These reflections are processed as a function of time to derive temperature as a function of well depth, with earlier reflections indicating the temperature at relatively shallow depths, and later reflections indicating the temperature at relatively deep depths. For example, an optical coupler 604 includes suitable optical elements to guide pump radiation down the waveguide 620 and guide backscattered light signals to a receiver 606.

The receiver 606 translates the backscattered light signals into electrical signals that are fed to a processor 608 capable of generating a distributed temperature profile therefrom. Such time-to-depth conversion is possible because the speed at which light travels through the waveguide 620 is known. Temperature may be derived from the reflections by computing the ratio of intensities between selected wavelengths in the reflections (e.g., through Raman backscattering analysis). Raman backscattering analysis is discussed, for example, in U.K. Published Patent Application 2,140,554 to Dakin, published November 1984, which is hereby incorporated by reference in its entirety. Through systematic pulses, the processor 608 is able to monitor temperature along the entire length of the waveguide 620. Hence, the optical waveguide acts as a temperature sensor, permitting the reading of temperature gradients and changes throughout the well.

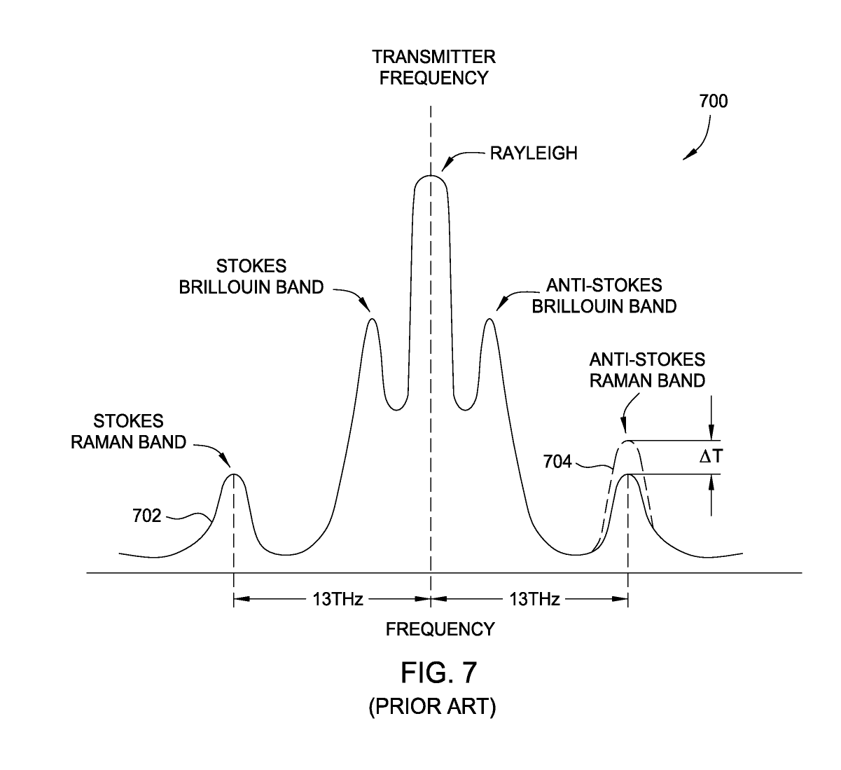

FIG. 7 is a graph 700 of light intensity versus frequency, illustrating a waveform 702 across a spectrum of backscattered light signals generated by the pump radiation. As illustrated, the backscattered signals include signals in Stokes and anti-Stokes Brillouin bands, as well as Stokes and anti-Stokes Raman bands. The Stokes and anti-Stokes Raman signals are typically processed by the processor 608 at the surface to calculate a ratio of power between upper and lower frequency bands of detected signals.

There is a known temperature dependence of this power ratio which allows for convenient temperature sensing based on the detected light signals backscattered to the surface. The anti-Stokes Raman signal is sensitive to temperature changes, which result in changes in amplitude of the anti-Stokes Raman signal (as illustrated by the dashed line 704), while the Stokes Raman signal is insensitive to temperature. Because the speed of light in the waveguide 620 is known, it is possible to determine positions along the waveguide at which scattering occurred, based on the time of arrival of the backscattered light signals. Hence, a Raman DTS system is capable of measuring temperature as a continuous function of position over a length of the waveguide, which may be correlated to a depth of the wellbore.

However, the accuracy of the above-described DTS system may be hindered by the signal propagation loss that occurs when the backscattered signals travel to the surface electronics, and this problem is compounded by the loss usually being different for the respective return wavelengths of the backscattered signals. Thus, practically, the ratio of the signal strengths of the backscattered signals provides a measure of the local temperature at a point of interest plus the cumulative difference in the losses at the respective return wavelengths of the signals. This is the case with single-ended DTS applications.

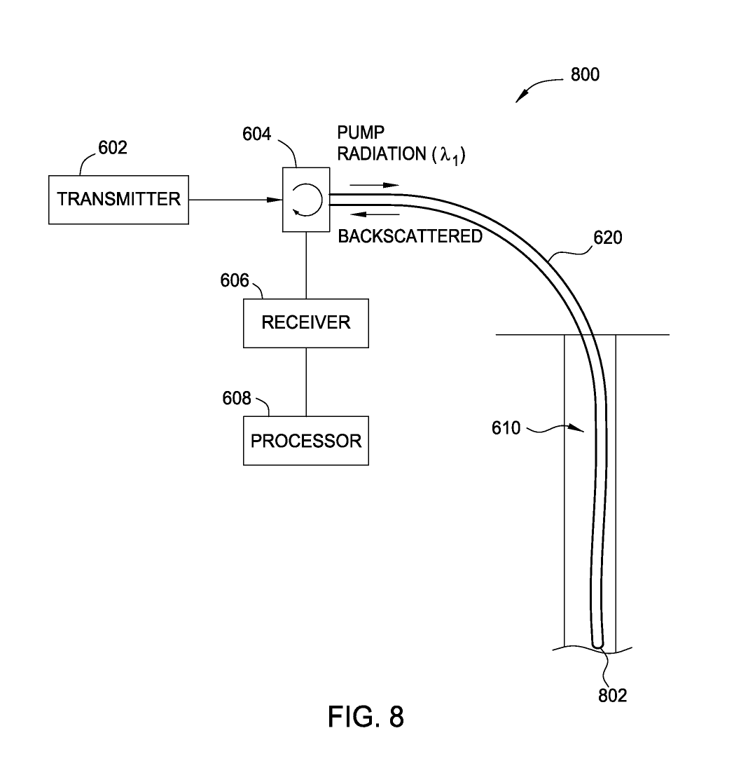

This system could be operated with increased accuracy if the differential losses of the backscattered signals were own. The effects of signal loss may be separated from those of temperature by double-ended operation, which entails looping the optical waveguide back to the surface electronics and repeating the measurement from the opposite end of the waveguide as shown in FIG. 8. The optical waveguide 620 in FIG. 8 may have a U-bend, looping waveguide 620 back to the surface. As temperature changes tend to appear in the same sense when viewed from opposite waveguide ends, whilst loss effects appear opposite in sense when viewed from either direction, these two parameters can be distinguished by combining the measurements obtained from the waveguide ends.

However, double-ended DTS systems typically occupy more space than single-ended systems. In applications where space is at a premium, such as in wellbores, it is desirable to devise a way in which Raman double-ended DTS systems could be deployed without taking up as much space as conventional double-ended systems. For example, the Raman double-ended DTS system 800 may use looped waveguide 620 (e.g., similar to downhole fiber optical cable 402) with a cane U-bend (e.g., cane segment 301 having U-bend 206) to form the turnaround in order to loop back. According to certain aspects, the waveguide 620 may be an optical fiber and may couple to a bent cane at both ends of the U-bend in order to turnaround for the loop back. The cane may be able to withstand higher pressures and temperatures than optical fiber for use in wellbore 610.

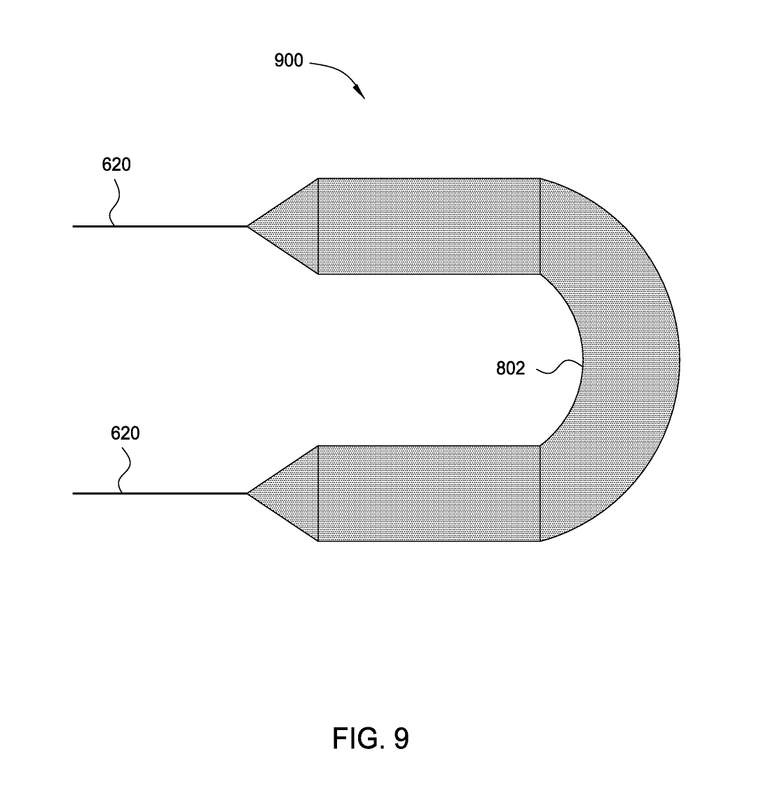

FIG. 9 illustrates an example zoomed-in view of U-bend 802, in accordance with certain aspects of the present disclosure. As shown in FIG. 9, the bent large diameter optical waveguide 900 may be bent with a U-bend 802 using the techniques described above (for example, with respect to FIGS. 1-2). The U-bend 802 may allow the bent large diameter optical waveguide 900 to be used for loop-back measurements to be performed, for example in Raman double-ended DTS system 800. According to certain aspects, the bent large diameter optical waveguide 900 may couple at each end to an optical waveguide 620 (e.g., such as an optical fiber).

According to certain aspects, bent cane may also be used for Brillouin distributed temperature and strain sensing (DTSS). An optical pump signal may introduced a first end of an optical fiber and a probe signal may be introduced at the other of the optical fiber.

### Small Form Factor Coiled Cane

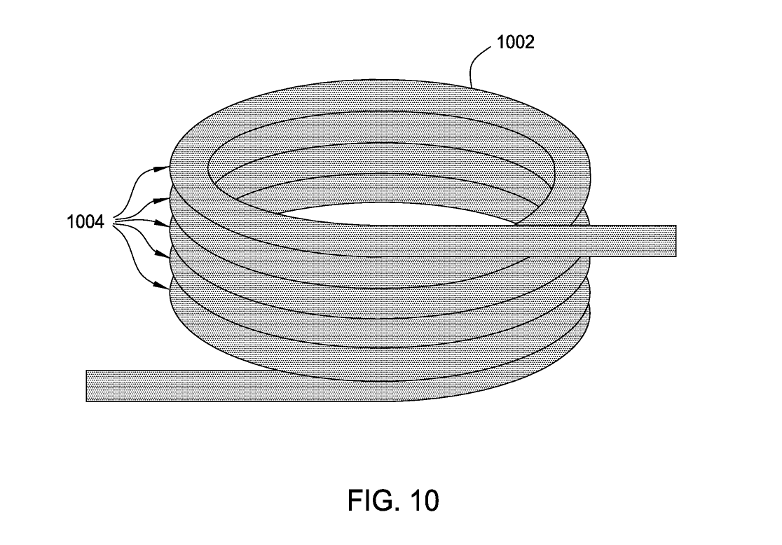

According to certain aspects, cane may be bent into coils for use as a high power amplifier/laser cane, for example. FIG. 10 illustrates an example bent large diameter optical waveguide 1002 shaped into a coil, in accordance with certain aspects of the present disclosure. As shown in FIG. 10, the waveguide 1002 may be bent into a coil using the bending techniques described above (e.g., with respect to FIGS. 1-2). The waveguide 1002 may be bent into any number of coils 1004. Bending cane into coils may allow the cane to be formed in a small package which may be useful for high power amplifier and laser applications. Coiling the cane may also have the effect of better mode mixing and pump/gain coupling, as well as easier cooling.

### Evanescent Field Sensors and Couplers

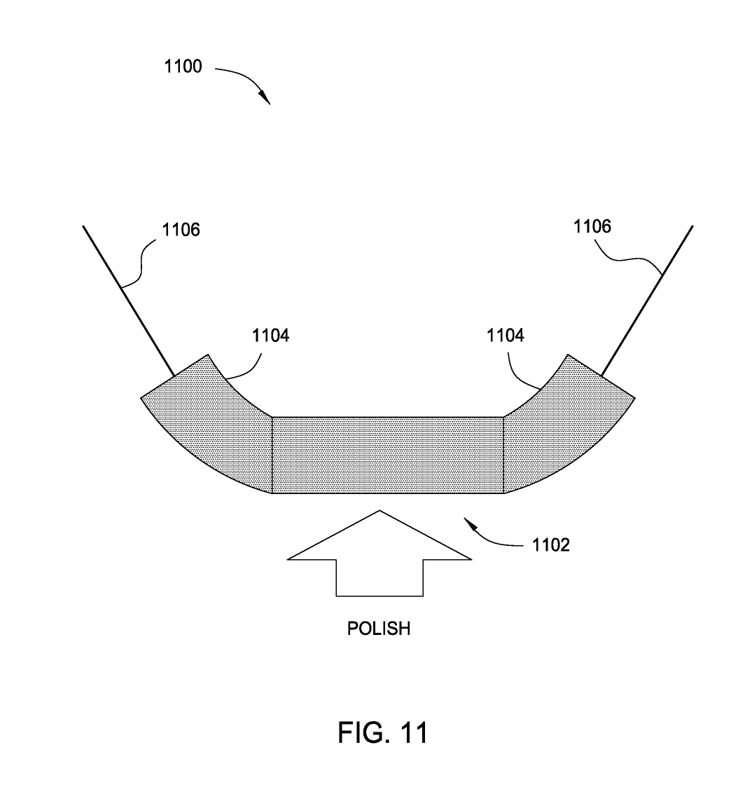

According to certain aspects, bent cane may be useful for side-polishing. FIG. 11 illustrates an example bent large diameter optical waveguide 1100, in accordance with certain aspects of the present disclosure. As shown in FIG. 11, the waveguide 1100 may including a large diameter optical waveguide 1102 bent to form pigtails 1104 that are bent out of the way, such that the surface of the large diameter optical waveguide 1102 may be polished (e.g., to form a flat surface) using any of various suitable polishing techniques. According to certain aspects, it may be desirable to polish the cane very close to the core (e.g., within 10-11 microns). Some portion of a light source may emit from the polished surface into the air, forming an evanescent field. Thus, the waveguide 1100 may be useful for evanescent field sensors and couplers. Each of the pigtails 1104 may be spliced to an optical fiber 1106 for optical communication with the bent waveguide 1100.

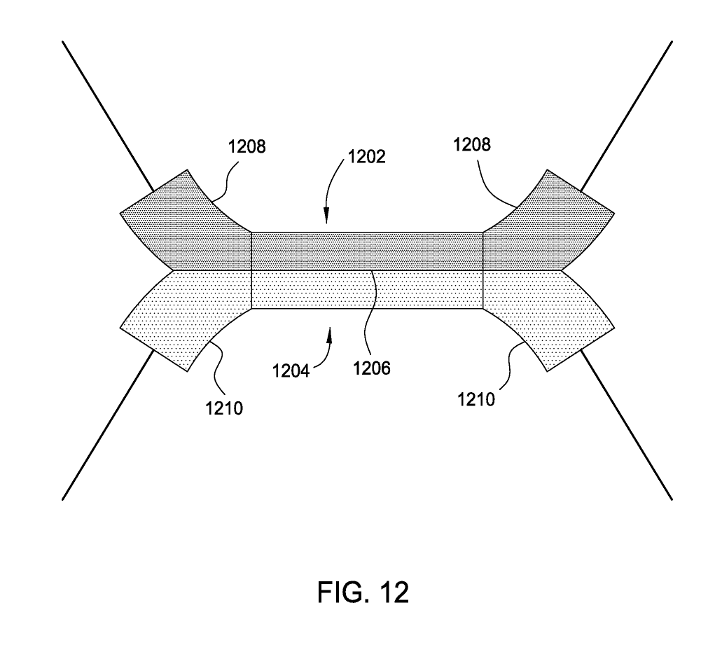

According to certain aspects, side-polished bent canes may be fused together with the polished edges butted against each other. Thus, the evanescent field of one cane may couple into the other cane, which may provide power transfer. FIG. 12 illustrates an example first polished bent large diameter optical waveguide 1202 fused with a second polished bent large diameter optical waveguide 1204, in accordance with certain aspects of the present disclosure. As shown in FIG. 12, the first waveguide 1202 may be bent such that pigtails 1208 are out of the way, and the second waveguide 1204 is also bent such that pigtails 1210 are out of the way. The first and second bent waveguides 1202, 1204 may be side-polished. The polished sides of the first bent waveguide 1202 and of the second bent waveguide 1204 may be fused at the interface 1206 of the polished sides. The fused polished cane may be suitable for very harsh environments.

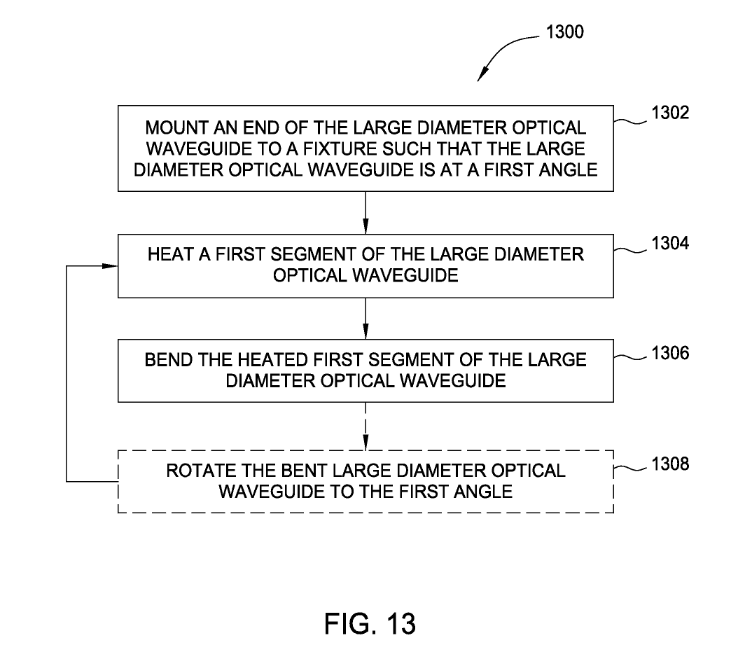

FIG. 13 is a flow diagram illustrating example operations 1300 for forming a large diameter optical waveguide having a bend, in accordance with certain aspects of the present disclosure. The operations 1300 may begin, at 1302, by mounting an end of the large diameter optical waveguide to a fixture such that the large diameter optical waveguide is at a first (e.g., approximately horizontal) angle. According to certain aspects, the large diameter optical waveguide may include a core and a cladding (e.g., having an outer diameter of 1 mm or larger) surrounding the core.

At 1304, a first segment of the large diameter optical waveguide may be heated (e.g., to, above, or near the melting point of the large diameter optical waveguide). For example, if the large diameter optical waveguide is composed of glass, the first segment of the large diameter optical waveguide may be heated (e.g, using a heating torch, large diameter arc splicer, electric element, or laser) to the melting point of the glass.

At 1306, the heated first segment of the large diameter optical waveguide may be bent (e.g., forced manually or using the weight of the heated large diameter optical waveguide under gravity). According to certain aspects, a first optical waveguide (e.g., an optical fiber or fiber pigtail) may be coupled to a first end of the large diameter optical waveguide, and/or a second optical waveguide (e.g., another optical fiber or fiber pigtail) may be coupled to a second end of the large diameter optical waveguide. For example, each of the first and second ends of the large diameter optical waveguide may be machined to a frustoconical section having a diameter approximately equal to a diameter of the first and second optical waveguides. Additionally, a first protective layer (e.g., a polyimide sleeve) may be provided at a first location where the first optical waveguide couples to the first end of the large diameter optical waveguide and a second protective layer (e.g., a polyimide sleeve) may be provided at a second location where the second optical waveguide couples to the second end of the large diameter optical waveguide. According to certain aspects, the bent first segment of the large diameter optical waveguide may be disposed in a metal housing and the bent first segment of the large diameter optical waveguide may be coupled to a cable via a passage through a wall of the metal housing.

According to certain aspects, the heated first segment of the large diameter optical waveguide may be bent vertically to some angle. As shown in FIG. 13, at 1308, the fixture may then be rotated such that the large diameter optical waveguide with the bent first segment is returned to the first (e.g., approximately horizontal) angle. A second segment of the large diameter optical waveguide adjacent to the first segment of the large diameter optical waveguide may then be heated and vertically bent to a second angle. By rotating, heating, and bending segments of the large diameter optical waveguide, the large diameter optical waveguide may be bent to a desirable configuration (e.g., 180° arc (U-bend) or coil). According to certain aspects, a side of the bent large diameter optical waveguide may be polished such that an evanescent field is formed when light passes through the polished bent large diameter optical waveguide. The polished bent large diameter optical waveguide may be coupled to another polished bent large diameter optical waveguide having another polished side with the polished sides abutting each other such that the evanescent field of the polished bent large diameter optical waveguide is coupled into the other polished bent large diameter optical waveguide.

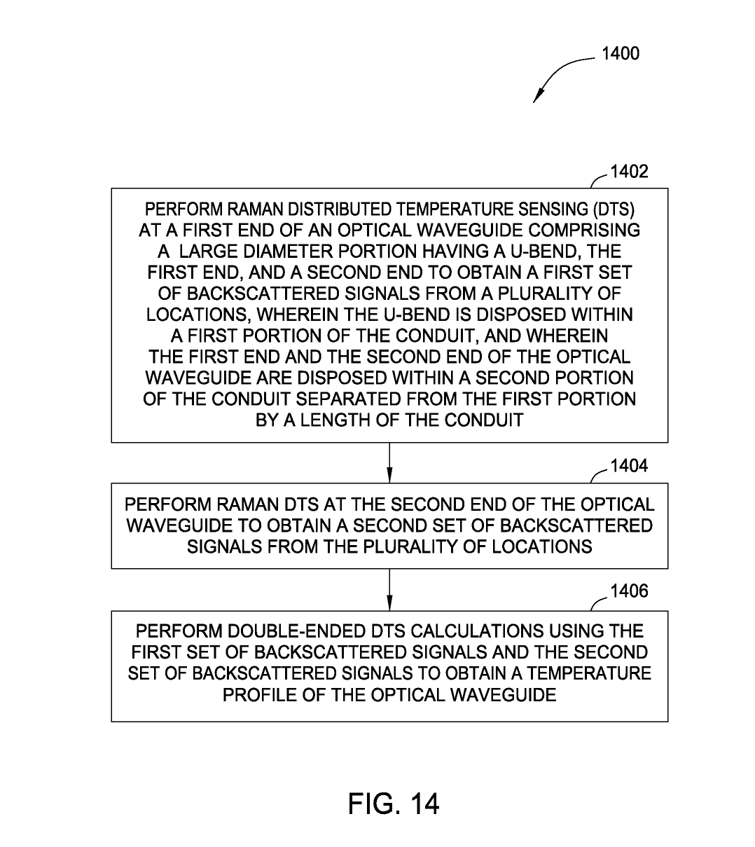

FIG. 14 is a flow diagram illustrating example operations 1400 for determining temperatures associated with a conduit, in accordance with certain aspects of the present disclosure. The operations 1400 may begin, at 1402, by performing Raman DTS at a first end of an optical waveguide (comprising a large diameter portion having a U-bend, the first end, and a second end) to obtain a first set of backscattered signals from a plurality of locations along the length of the optical waveguide. The U-bend may be disposed in a first portion of the conduit. The first end of the optical waveguide may be disposed in a second portion of the conduit, which may be separated by a length of conduit from the first portion. The second end of the optical waveguide may also be disposed in the second portion of the conduit. At 1404, Raman DTS may be performed at the second end of the optical waveguide to obtain a second set of backscattered signals from the plurality of locations. At 1406, double-ended DTS calculations may be performed using the first set of backscattered signals and the second set of backscattered signals to obtain a temperature profile of the optical waveguide.

According to certain aspects, the optical waveguide may also include an optical fiber portion coupled to the large diameter portion. In this case, the first end and/or the second end may be located in the optical fiber portion.

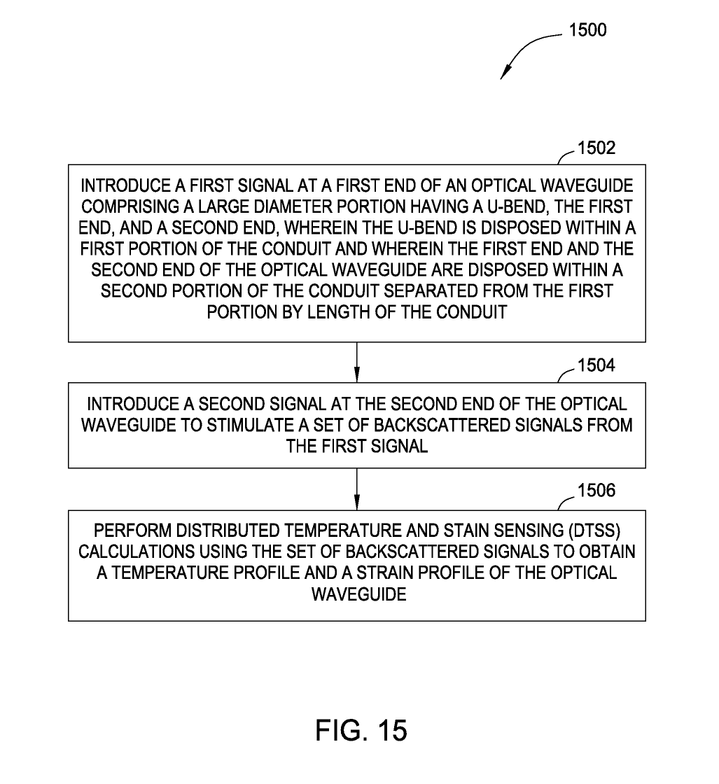

FIG. 15 is a flow diagram illustrating example operations 1500 for determining temperatures and strains associated with a conduit, in accordance with certain aspects of the present disclosure. The operations 1500 may begin, at 1502, by introducing a first signal (e.g., a probe signal) at a first end of an optical waveguide comprising a large diameter portion having a U-bend, the first end, and a second end, wherein the U-bend is disposed within a first portion of the conduit and wherein the first end and the second end of the optical waveguide are disposed within a second portion of the conduit separated from the first portion by a length of the conduit. At 1504, a second signal (e.g., a pump signal) may be introduced at the second end of the optical waveguide to stimulate a set of backscattered signals from the first signal. At 1506, distributed temperature and strain sensing (DTSS) calculations may be performed using the set of backscattered signals to obtain a temperature profile and a strain profile of the optical waveguide.

Aspects of the present disclosure may offer several advantages over conventional solutions. The cane-based U-bend may be more ruggedized and more reliable than fiber optic U-bends. Bent cane configurations may have several applications including angling input/output connections on a cane sensor to allow side-polishing using conventional techniques, compact packaging of large diameter amplifier waveguides for high-power and high-energy laser systems, compact monolithic U-turns, and monolithic couplings for harsh environments. The bent cane configurations described herein may also allow a unique approach for performing loop-back measurements, such as DTS.

While the foregoing is directed to aspects of the present disclosure, other and further aspects of the disclosure may be devised without departing from the basic scope thereof, and the scope thereof is determined by the claims that follow.

1. A method for forming a large diameter optical waveguide having a bend, comprising:
mounting an end of the large diameter optical waveguide to a fixture such that the large diameter optical waveguide is at a first angle;
heating a first segment of the large diameter optical waveguide; and
bending the heated first segment of the large diameter optical waveguide.

2. The method of claim 1, wherein the large diameter optical waveguide comprises a core and a cladding surrounding the core and wherein the cladding has an outer diameter of at least 0.5 mm.

3. The method of claim 1, wherein:
the large diameter optical waveguide is composed of glass; and
heating the first segment of the large diameter optical waveguide comprises heating the first segment of the large diameter optical waveguide to the melting point of the glass.

4. The method of claim 1, wherein heating the first segment of the large diameter optical waveguide comprises heating the first segment of the large diameter optical waveguide using at least one of: a heating torch, a large diameter arc splicer, an electric element, or a laser.

5. The method of claim 1, further comprising:
coupling a first optical waveguide to a first end of the large diameter optical waveguide and a second optical waveguide to a second end of the large diameter optical waveguide.

6. The method of claim 5, wherein at least one of the first or second optical waveguide comprises a fiber pigtail.

7. The method of claim 5, wherein coupling the first and second optical waveguides to the first and second ends of the large diameter optical waveguide comprises machining each of the first and second ends of the large diameter optical waveguide to a frustoconical section having a diameter approximately equal to a diameter of the first and second optical waveguides.

8. The method of claim 5, further comprising:
providing a first protective layer at a first location where the first optical waveguide couples to the first end of the large diameter optical waveguide; and
providing a second protective layer at a second location where the second optical waveguide couples to the second end of the large diameter optical waveguide.

9. The method of claim 1, further comprising:
disposing the bent first segment of the large diameter optical waveguide in a metal housing; and
coupling the bent first segment of the large diameter optical waveguide to a cable via a passage through a wall of the metal housing.

10. The method of claim 1, wherein bending the heated first segment of the large diameter optical waveguide comprises manually or mechanically applying a force to bend the heated first segment.

11. The method of claim 1, wherein bending the heated first segment of the large diameter optical waveguide comprises allowing the heated first segment to bend under its own weight by gravity.

12. The method of claim 1, wherein bending the heated first segment of the large diameter optical waveguide comprises:
vertically bending the heated first segment of the large diameter optical waveguide to a second angle;
rotating the fixture such that the large diameter optical waveguide with the bent first segment is at the first angle;
heating a second segment of the large diameter optical waveguide; and
bending the second segment of the large diameter optical waveguide to a third angle.

13. The method of claim 1, wherein bending the first segment of the large diameter optical waveguide comprises bending the first segment of the large diameter optical waveguide to form a 180° arc.

14. The method of claim 1, wherein bending the first segment of the large diameter optical waveguide comprises bending the first segment of the large diameter optical waveguide to form one or more coils.

15. A method for determining temperatures associated with a conduit, the method comprising:
performing Raman distributed temperature sensing (DTS) at a first end of an optical waveguide comprising a large diameter portion having a U-bend, the first end, and a second end to obtain a first set of backscattered signals, wherein the U-bend is disposed within a first portion of the conduit and wherein the first end and the second end of the optical waveguide are disposed within a second portion of the conduit separated from the first portion by a length of the conduit;
performing Raman DTS at the second end of the optical waveguide to obtain a second set of backscattered signals;
performing double-ended DTS calculations using the first set of backscattered signals and the second set of backscattered signals to obtain a temperature profile of the optical waveguide.

16. The method of claim 15, wherein the optical waveguide further comprises an optical fiber portion coupled to the large diameter portion, and wherein the first end and the second end are located in the optical fiber portion.

17. A system for determining temperatures associated with a conduit, the system comprising:
an optical waveguide disposed in the conduit, the waveguide comprising a first end, a second end, and large diameter portion having a U-bend;
an optical source for introducing pulses of light into the first end and the second end of the optical waveguide; and
at least one processor configured to:
perform Raman distributed temperature sensing (DTS) using the first end of the optical waveguide to obtain a first set of backscattered signals;
perform Raman DTS using the second end of the optical waveguide to obtain a second set of backscattered signals;
perform double-ended DTS calculations using the first set of backscattered signals and the second set of backscattered signals to obtain a temperature profile of the optical waveguide.

18. The system of claim 17, wherein:
the first end and the second end of the optical waveguide are disposed within a first portion of the conduit; and
the U-bend is disposed within a second portion of the conduit separated from the first portion by a length of the conduit.

19. A bent large diameter optical waveguide for downhole sensing, comprising:
a core;
a cladding disposed around the core, wherein the core and the cladding are bent and wherein the cladding has an outer diameter of at least 1 mm; and
a sleeve disposed around the cladding.

20. The bent large diameter optical waveguide of claim 19, wherein the sleeve comprises a polyimide sleeve.

21. The bent large diameter optical waveguide of claim 19, wherein the sleeve is able to withstand temperatures of at least 300° C.

22. The bent large diameter optical waveguide of claim 19, wherein the core and the cladding are bent to form a 180° arc.

23. The bent large diameter optical waveguide of claim 19, wherein the optical waveguide is free of bending stress.

24. A method for determining temperatures and strains associated with a conduit, the method comprising:
introducing a first signal at a first end of an optical waveguide comprising a large diameter portion having a U-bend, the first end, and a second end, wherein the U-bend is disposed within a first portion of the conduit and wherein the first end and the second end of the optical waveguide are disposed within a second portion of the conduit separated from the first portion by a length of the conduit;
introducing a second signal at the second end of the optical waveguide to stimulate a set of backscattered signals from the first signal;
performing distributed temperature and strain sensing (DTSS) calculations using the set of backscattered signals to obtain a temperature profile and a strain profile of the optical waveguide.

25. The method of claim 24, wherein the first signal comprises a probe signal.

26. The method of claim 24, wherein the second signal comprises a pump signal.
